(19) United States
(12) Patent Application Publication
(10) Pub. No.: US 2015/0169772 A1
(43) Pub. Date: Jun. 18, 2015

(54) Personalizing Search Results Based on User-Generated Content

(71) Applicant: Microsoft Corporation, Redmond, WA (US)

(72) Inventors: Omar Alonso, Redwood Shores, CA (US); Xavier Legros, Woodside, CA (US); Kevin Lee Haas, Los Gatos, WA (US)

(73) Assignee: MICROSOFT CORPORATION, Redmond, WA (US)

(21) Appl. No.: 14/104,573

(22) Filed: Dec. 12, 2013

(51) Int. Cl. G06F 17/30

(52) U.S. Cl. CPC G06F 17/30867

(57) ABSTRACT

Systems, methods, and media for responding to search queries from a computer user with personalized search results are presented. A user vector is generated for a user. The user vector is generated by repeatedly accessing a plurality of network sites to obtain user-generated content, and updating the user vector according to the user-generated content. Moreover, a plurality of search results is identified in response to a query. Each of the search results is associated with a score. A user vector is obtained and the scores of the search results are weighted. A subset of the search results having favorable scores is selected and a search results page is generated from the subset of search results. The generated search results page is returned in response to the search query.

### BACKGROUND

Search engines increasingly strive to personalized search results in response to search queries. Search engines personalize search results for a computer user by taking into account the user's current context (location, type of device, time of day, etc.), the user's prior searching and browsing behaviors, the user's preferences—both implicitly and explicitly identified to the search engine, and the like.

While a search engine may receive explicit information regard a computer user's preferences, as well as be able to implicitly identify a user's preferences through the user's interaction with the search engine, there is a substantial amount of online information that the user generates that is not considered. Indeed, users often subscribe to a variety of services and sites on the Internet. For example, a user may subscribe (or otherwise interact with) one or more social networking sites, one or more news sites, college alumni sites, various special interest sites, and the like. Typically (though not exclusively), in interacting with a network site the user will provide information about himself/herself. While each site may take advantage of the information that a user provides to gain insight into the user, the insight is limited in scope by the nature of the subject matter and interaction of a particular site.

### SUMMARY

The following presents a simplified summary in order to provide a basic understanding of various embodiments described herein. This summary is not an extensive overview, and it is not intended to identify key and/or critical elements or to delineate the scope thereof. The sole purpose of this summary is to present some concepts in a simplified form as a prelude to the more detailed description that follows.

Systems, methods, and media for responding to search queries from a user with personalized search results are presented. A user vector is generated for a user. The user vector is generated by repeatedly accessing a plurality of network sites to obtain user-generated content, and updating the user vector according to the user-generated content. Moreover, a plurality of search results is identified in response to a query. Each of the search results is associated with a score. A user vector is obtained and the scores of the search results are weighted. A subset of the search results having favorable scores is selected and a search results page is generated from the subset of search results. The generated search results page is returned in response to the search query.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a diagram of an exemplary networking environment suitable for implementing graph-based searching;

FIG. 2 is a flow diagram illustrating an exemplary routine for generating a user vector through aggregating user generated content from multiple network sites;

FIGS. 3A and 3B are pictorial diagrams illustrating an exemplary use vector as may be generated according to aspects of the disclosed subject matter;

FIG. 4 is a flow diagram illustrating an exemplary routine 400 for providing personalized search results according to user-generated content; and

FIG. 5 illustrates exemplary components of a search engine suitably configured to implement aspects of the disclosed subject matter.

### DETAILED DESCRIPTION

For purposes of clarity, the use of the term “exemplary” throughout this document should be interpreted as serving as an illustration or example of something, and it should not be interpreted as an ideal and/or a leading illustration of that thing. Unless explicitly indicated to the contrary, the terms “computer user” and “user” are synonymous and should be interpreted as a user of computers, including a person or entity capable of providing user-generated content on various network sites.

As used herein, “hyperlink” (also referred to as a “link”) is a reference to data/content at a target site. In some instances, when displayed on a Web browser on a user computer, a hyperlink is user actionable such that, upon activating (e.g., selecting) the hyperlink, the referenced content replaces the current content in the browser. Generally speaking, search results (the information returned from a search engine in response to a search query), are hyperlinks referencing corresponding content at a target sites. Search results in the search results pages are often presented as user-actionable links, commonly displayed in blue to indicate to the user the ability to select (or activate) the link, enabling the user to the referenced content at a target site.

As used in this document, “user-generated content” refers to data or information generated or provided by a user on one or more networked sites. The user-generated content may include information provided in the form of answers to questions, such as, by way of illustration and not limitation, where did you go to school, where have you worked, are you married, how many kids, etc. Similarly, user-generated content may comprise more free-form information such as (by way of illustration and not limitation) posts, comments, blogs, likes, etc.

The user-generated content can be analyzed to identify various interests and attributes of the user. Typically, but not exclusively, user-generated content is obtained from a variety of network sites, including social networking sites such as social networking site 116, and analyzed in the aggregate.

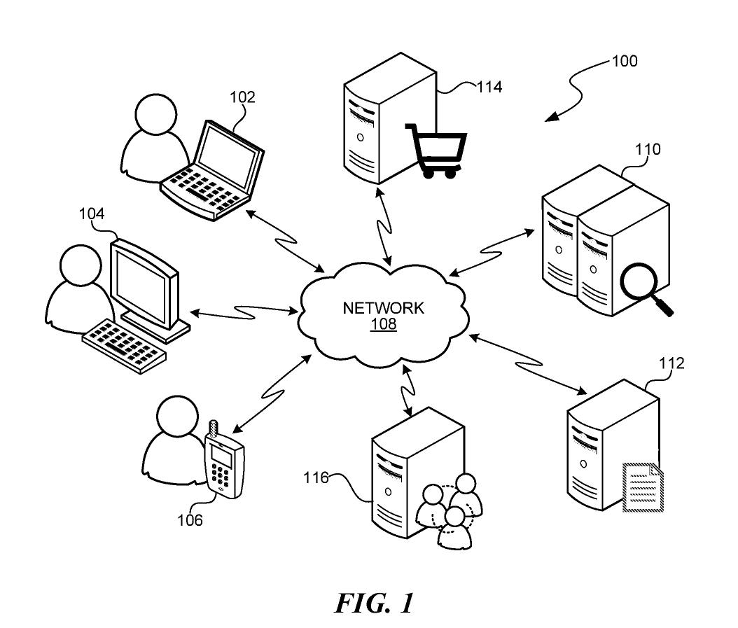

Turning to FIG. 1, this figure shows an illustrative environment 100 suitable for implementing aspects of the disclosed subject matter, particularly in regard to personalizing search results based on user-generated content. The illustrative environment 100 includes one or more user computers, such as user computers 102-106. User computers include, by way of illustration and not limitation: desktop computers; laptop computers; tablet computers; smart phones; game consoles; personal digital assistants; and the like.

These user computers typically, though not exclusively, are connected to a network 108, such as the Internet, a wide area network or WAN, and the like. As such, these user computers are at connected (via the network 108) to other computers and/or devices on the network. For example, as shown in FIG. 1, also connected to the network 108 is a search engine 110. Those skilled in the art will appreciate that the search engine 110 corresponds to an online service hosted by one or more computers or computing systems distributed throughout the network 108. As shown in FIG. 1, the search engine 110 comprises two computing devices. However, this should be viewed as illustrative only and not limiting upon the disclosed subject matter.

As will be discussed below, a suitably configured search engine 110 responds to search queries with the requested information. In particular, according to aspects of the disclosed subject matter, in response to receiving a search query, the search engine 110 identifies relevant content according to query terms of the search query. After identifying relevant content responsive to the user query, the search engine 110 personalizes the search results according to user-generated content, generates one or more search results pages from the personalized search results, and returns at least one search results page to the requesting user.

The illustrative environment is also shown as including a social networking site 116, a blog site 112, and a shopping site 114. Those skilled in the art will appreciate that social networking sites, such as social networking site 116, enable a user to connect to others (including friends, peers, family members, organizations, and the like) for keeping up-to-date with each other and sharing information. Examples of social networking sites include, by way of illustration and not limitation, Facebook, Google+, MySpace, Twitter, and the like. As those skilled in the art will appreciate, computer users typically generate substantial amounts of content (such as likes, posts, comments, and the like) with regard to other entities in their social networks. Similarly, as will be readily appreciated, blog sites, such as block site 112, allow users to post content for others to view. By way of illustration, a user may make posts of the daily events corresponding to a vacation such that others (interested parties) may view remain appraised of the activities of the posting user. These blogs/postings may certainly be viewed as user generated content. In some instances, some blog sites allow for content threads, various parties can interact on a topic or topics. Still further, shopping sites, such as shopping site 114, allow a user to conduct transactions for various items and/or services. The fact that the user purchases an item may be viewed as user generated content for that user. Additionally, shopping sites also frequently allow a user to review and grade items that have been purchased. Of course, this information may also be viewed as user generated content.

As can be seen, computer users generate a substantial amount of user generated content throughout various devices and sites on the Internet. According to aspects of the disclosed subject matter, this user generated content can be aggregated into user vectors to personalize a user's online experience, including personalizing search results to a search query. As will be described in greater detail below, a user vector corresponds to an array of data items. According to various embodiments, the user vector may be implemented as an un-ordered collection of labeled data items. Each data item represents a particular piece of information/data of the associated user. These data items include, by way of illustration and not limitation: facts, which may be static or dynamic in nature, such as age, gender, where and when the user went to school, where and when the user work, where the years are currently lives, and the like; user preferences, e.g., enjoys role-playing computer games, likes contemporary fiction, prefers popular music, dislikes classical music, and the like. Typically, though not exclusively, the user vector is implemented as a sparse array of data items, and in any given user vector a data item corresponding to a particular piece of information may or may not be present. In other words, a user vector for a first user may include elements corresponding to a particular topic that may not be present in the user vector of another user.

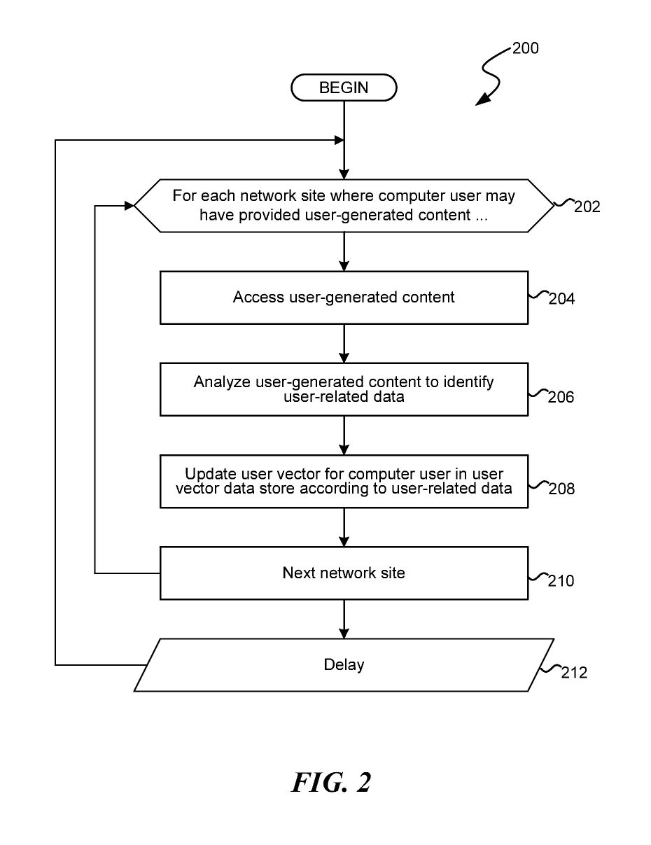

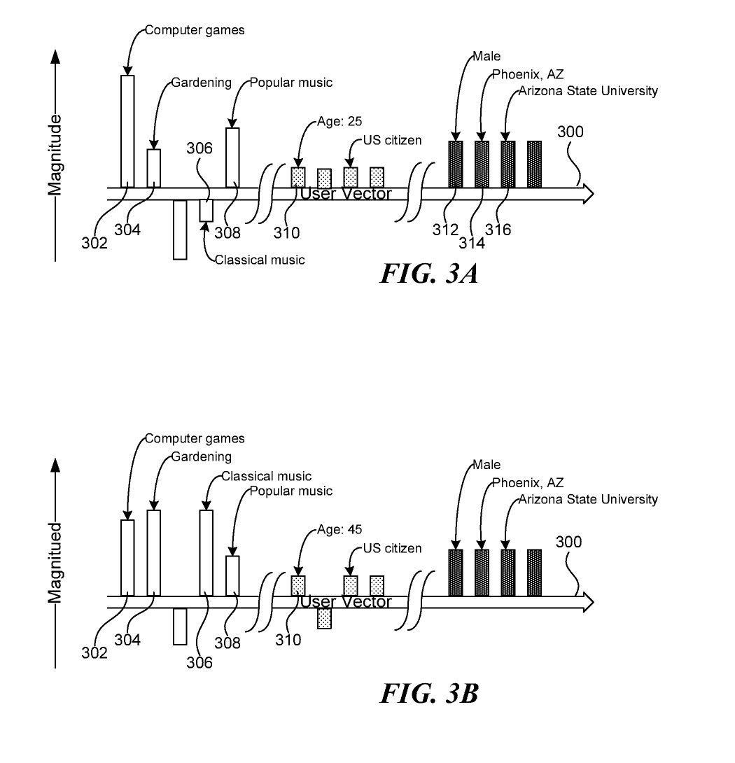

Turning now to FIG. 2 in conjunction with FIGS. 3A and 3B, FIG. 2 is a flow diagram illustrating an exemplary routine 200 for generating a user vector through aggregating user generated content from multiple network sites, and FIGS. 3A and 3B are pictorial diagrams illustrating a use vector 300. Beginning at block 202, a looping process is begun in which the routine 200 (as illustratively implemented on a computing device, such as a computing device operating by the search engine 110) iterates through network sites where a user may have provided user-generated content. Thus, at block 204, the routine 200 accesses user-generated content for the user at the current network site. At block 206, the routine 200 analyzes the user-generated content to identify user-related data. User-related data corresponds to information about the user, i.e., age, gender, schools attended, preferences in music, and the like. Analyzing data to identify user-related data is known in the art.

After identifying the user-related data from the user-generated content, at block 208 a user vector corresponding to the computer user is updated (or created if it does not already exist) with the user-related data. As indicated above, a user vector is a “vector” of data items corresponding to pieces of information about and preferences of the associated user. Typically, though not necessarily, preferences are associated with a strength or amplitude of preference (or dislike). For example, FIG. 3A illustrates an exemplary user vector 300. The user vector 300 includes various data items, such as data items 302-316. For illustration purposes, a first set of data items (302-308) correspond to preferences with (for illustration purposes) a positive preference for an item rising above the user vector 300 and a negative preference for data items falling below the user vector. Moreover, the distance from the user vector 300 indicates the strength of the positive or negative preference. Thus, in FIG. 3A, the user's preference for computer games, as represented by data item 302, is strong, whereas the negative preference for classical music, as represented by data item 306, is not as strong. By way of description, also included in the illustrated user vector 300 are dynamic data items (corresponding to facts regarding the user) that are included in the second group of data items, e.g., data item 310 corresponding to the user's age, and static data item (corresponding to facts that are typically immutable) that are displayed in the third group of data item, e.g., data items 312-316 that indicate the user's gender, birthplace, where the user graduated from college, and the like. Of course, the group of types of preferences is for illustration purposes only, and should not be construed as limiting upon the disclosed subject matter.

As mentioned, the routine 200 may create or update the user vector according to the latest information. This “update” reflects the fact that much of the user-related data in the user vector is dynamic. Over time, a user's preferences may change, additional schools may be added, residency changed, etc. FIG. 3B illustrates the exemplary user vector 300 as may exists at some time later (than that of the user vector in FIG. 3A) in the user life. As can be seen, the user's preference for computer games is slightly less (as indicated by data item 302) and the user's view of classical music has changed from a slightly negative preference to a strong positive preference, as indicated by data item 306. The data items 302-308 then reflect the preferences and magnitude at the current time for the user.

After updating the user vector according to the identified user-related data, the routine 200 proceeds to the next network site that holds user-generated content, if there are any more from which user-generated content may be accessed. Assuming that there are more network sites, the routine 200 returns to block 202 where the above described steps are repeated. Alternatively, if there are no more network site, the routine 200 proceeds to block 212. At block 212, the routine delays for a predetermined amount of time (such as a day, a week, an hour, etc., if at all) before repeating/returning to the process described above. In this manner, the process continually or periodically updates the user vector for the user based on the aggregated user-generated content.

While routine 200 is described above in regard to generating and/or updating a user vector for a specific user, this is for illustration purposes and should not be construed as limiting upon the disclosed subject matter. In various embodiments, as each potential network site is accessed, information regarding user-generated content for multiple users is identified and the user vectors for the corresponding multiple users are generated and/or updated.

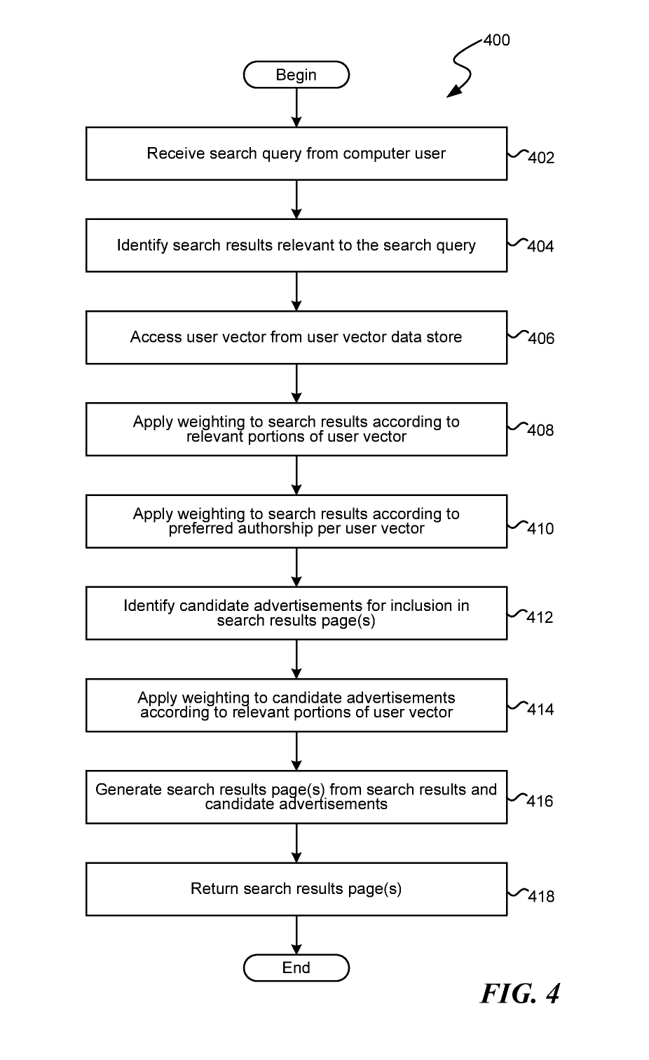

Having generated a user vector based on user-generated content, a service may suitably modify the user's experience according to the user vector. To this end, FIG. 4 is a flow diagram illustrating an exemplary routine 400 for providing personalized search results according to user-generated content. For purposes of description, the routine 400 will be described in the context of a search engine 110.

As a preliminary matter for routine 400, in order to permit a search engine 110 to personalize search results according to user generated content, according to aspects of the disclosed subject matter a user must be “logged in” (i.e., have established a “logged in” status with the search engine.) As will be readily appreciated, a user is “logged in” by establishing his/her identity with a site/service and authenticating the identity with the site/service, typically though not exclusively by way of a password. According to various embodiments of the disclosed subject matter, the user may be logged in directly with the search engine 110. Alternatively, the user may be logged in with a related networked site, such as social network site 116, such that the search engine 110 may be able to determine the identity and authenticity of the user from the related networked site. As will be appreciated, the status of being “logged in” may persist between active sessions with the search engine 110 (or related networked sites) such that the user does not need to establish his/her identity each time the search engine is accessed. As will be further appreciated, persisting a logged in state may be accomplished by way of various techniques including but not limited to temporary files that are maintained on the computer user's computer, sometimes referred to as “cookies.”

As will be appreciated, if a search engine does not know the identity of the requesting computer user, the search engine cannot personalize search results according to user generated content of the requesting user. Of course, there are various techniques in which the search engine may implicitly identify a requesting user (e.g., the IP address at which the requesting user is operating, “cookies” that include information about the user but do not include login information, and the like). However, relying on implicit identification of a user may pose personal security risks for the user and may prevent the search engine from accessing the user generated content from various network sites.

Generally speaking, when an unidentified user submits a search query, the search engine 110 is likely unable to generate and/or identify a user vector corresponding to the requesting user and identifies search results for the search query according to default parameters (i.e., most common search results for the submitted search query, general geographic area of the IP address of the requesting user, the IP domain of the requesting user, and the like.) Thus, assuming that the user submits a search query for movies of a favorite actor, if the user has established a preference for dramatic movies over comedies in the user's user vector but has failed to establish a logged in status with the search engine (directly or via related networked site), then that element of the user vector would not be used in personalizing the search results that are returned to the user. Alternatively, if the user has established a logged in status with the search engine, when the search query for movies featuring the user's favorite actor is received, the search engine can personalize the search results for the user according to the user vector, including the preference for dramatic movies over comedies. Accordingly, for purposes of the discussion of routine 400, it is assumed that the user has a “logged in” status.

Beginning at block 402, the search engine 110 receives a search query from a user. At block 404, the search engine identifies search results that are relevant to the query term (or terms) of the search query. As will be appreciated, the search results are associated with corresponding scores indicating the likelihood that the search result would be desired by the requesting user in response to the search query. According to various embodiments, the score may reflect a general popularity of the search result, the strength of the search result to the search query, and the like.

At block 406, the search engine 110 accesses a user vector for the requesting user from a user vector data store. At block 408, the search engine 110 applies weighting to the scores of the search results according to the applicable data items of the requesting user's user vector. The result of this weighting is to favor or disfavor various search results according to the user's user vector. In other words, if an applicable data item (applicable to the search result) is found in the user vector, a weighting value (which may be based on a magnitude of the preference for or against the particular data item) is applied to score of the search result. Moreover, weighting can be applied in the aggregate: if two or more data items of a user vector are applicable to the search query, then (in at least one embodiment) the weighting of the score for the search result may be an aggregate of the various data items.

In addition to weighting the search results according to the user vector, at block 410 the search engine makes a further connection by weighting search results according to preferred authorship. In particular, the search engine 110 determines whether any data items in the user vector indicate a preference (either positive or negative) regarding a particular author, such as data item 304. When these exist in the user vector, the search engine weights search results that are authored by that particular author as a function of the amplitude of preference (for or against) to that author.

At block 412, candidate advertisements are identified for inclusion with the search results to be returned to the user. As those familiar with search engines will appreciate, as the search services that a search engine provides is typically free to the user, in order to defray the costs of operating the search engine, the search engine will include advertisements for which advertisers pay the search engine. As with search results, advertisements may be scored according to various criteria (fulfillment goals, relevance to the search query, popularity of advertised product, and the like) such that those scoring favorably high the highest likelihood of being included with the search results that will be returned to the user.

After identifying candidate advertisements to be included with the search results, at block 414 the search engine applies weighting to the candidate advertisements based on the user vector. As with the search results, applying weighting to the candidate advertisements may alter, either favorably or unfavorably, the scores associated with one or more of the candidate advertisements.

At block 416, one or more search results pages are generated from the identified search results (based on the weighted scores of the search results). Additionally, one or more candidate advertisements are included in the one or more search results pages, where the candidate advertisements are selected according to their weighted scores. After generating the one or more search results pages, at block 418 at least one search results page is returned to the requesting user in response to the search query. This at least one search results page includes those search results and advertisements that scores most favorably after the weighting of the user vector was applied. Thereafter, the routine 400 terminates.

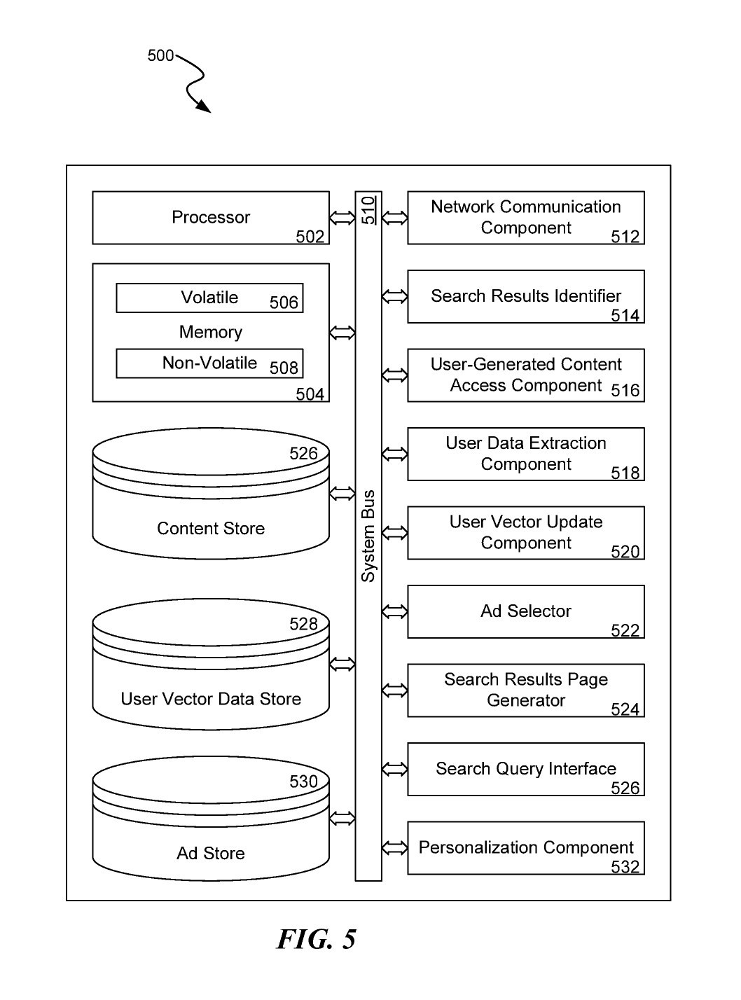

Regarding the exemplary routines 200 and 400 described above, while these routines are expressed in regard to discrete steps, these steps should be viewed as being logical in nature and may or may not correspond to any actual and/or discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that the described, logical steps of these routines may be combined together or be comprised of multiple steps. Steps of routines 200 and 400 may be carried out in parallel or in series. Often, but not exclusively, the functionality of the various routines is embodied in software (e.g., applications, system services, libraries, and the like) that is executed on computer hardware and/or systems as described below in regard to FIG. 5. In various embodiments, all or some of the various routines may also be embodied in hardware modules, including but not limited to system on chips, specially designed processors and or logic circuits, and the like on a computer system.

While many novel aspects of the disclosed subject matter are expressed in routines embodied in applications, also referred to as computer programs, apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions stored on the computer-readable storage devices are executed, they carry out various steps, methods and/or functionality, including the steps described above in regard to routines 200 and 400. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to FIG. 5, this figure illustrates exemplary components of a search engine 110 suitably configured to implement aspects of the disclosed subject matter including personalizing search results based on user-generated content from various network sites. As shown, the exemplary search engine 110 includes a processor 502 and a memory 504 interconnected by way of a system bus 510. As those skilled in the art will appreciated, memory 504 typically (but not always) comprises both volatile memory 506 and non-volatile memory 508. Volatile memory 506 retains or stores information so long as the memory is supplied with power. In contrast, non-volatile memory 508 is capable of storing (or persisting) information even when a power source is not available. Generally speaking, RAM and CPU cache memory are examples of volatile memory whereas ROM and memory cards are examples of non-volatile memory. Other examples of non-volatile memory include storage devices, such as hard disk drives, solid-state drives, removable memory devices, and the like.

The processor 502 executes instructions retrieved from the memory 504 in carrying out various functions, particularly in regard to responding to search queries with fresh product listing advertisements. The processor 502 may be comprised of any of various commercially available processors such as single-processor, multi-processor, single-core units, and multi-core units. Moreover, those skilled in the art will appreciate that the novel aspects of the disclosed subject matter may be practiced on various computers and/or computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; game consoles, and the like.

The system bus 510 provides an interface for the various components to inter-communicate. The system bus 510 can be of any of several types of bus structures that can interconnect the various components (including both internal and external components). The exemplary computing system 500 also includes a network communication component 512 for interconnecting the computing system 500 with other computers, devices and services on a computer network, such as user computers 102-106, blog site 112, shopping site 114 and social networking site 116. The network communication component 512 may be configured to communicate with these other, external devices and services via a wired connection, a wireless connection, or both.

The exemplary computing system 500 includes a search results identifier 514 that determines the subject matter of the received search query and identifies one or more search results from a content store 526. Typically, though not exclusively, the one or more search results that are identified by the search results identifier 514 are associated with corresponding scores indicating the likelihood that the search result is relevant to the requesting user. In this manner (i.e., that the search results are scored) the identified search results may be thought of as an ordered list of search results, ordered according to their scores. The content store stores references to content (e.g., documents, images, web pages, etc.) available throughout the network 108. Typically, though not exclusively, the content store 526 is indexed according to a plurality of keys based on plurality of topics.

Another component of the exemplary computing system 500 is the user-generated content access component 516. The user-generated content access component 516 is configured to access the various network sites, via the network communication component 512, which may host user-generated content. When user-generated content is encountered, the content is then provided the user data extraction component 518 which identifies data within the user-generated content that pertains to a user. After identifying the data pertaining to a user, the information is passed to a user vector update component 520 that creates and/or updates the user vector corresponding to the user associated with the user data. The user vector is stored in a user vector data store 528, and subsequently retrieved from the user vector data store when the computing system 500 responds to a search query.

The ad selector 522 selects one or more ads (advertisements) from an ad store 530 to be included with the search results that are returned to the computer user in response to a search query. As those skilled in the art will appreciate, online search engines typically offer their search services to users as a “free” service: i.e., the user does not have to pay for the search queries that are submitted. However, to offer this “free” service, search engines typically include advertisements from one or more advertisers with the search results of a search query that returned to the user. Generally speaking, advertisers pay a search engine for including the advertisements in the search results. Selecting advertisements to be included with search results to a search query is known in the art. However, according to aspects of the disclosed subject matter, the ad selector 522 may select advertisements according to elements of the user vector associated with the requesting user. In this manner, the ad selector 522 personalizes the advertisement selection according to user generated content.

The search query interface 526 fields search queries from requesting users and, in response to a search query, identifies search results by way of the search results identifier 514. In addition to identifying the search results, the search query interface 526 personalizes the identified search results according to the requesting user by way of the personalization component 532. The personalization component obtains the user vector corresponding to the requesting user and updates the scores of the identified search results according to the information in the search vector (as described above in regard to routine 400 of FIG. 4). The personalized search results are then provided to the search results pages generator 524 that generates one or more search results according to the search results identified by the search results identifier 514. According to aspects of the disclosed subject matter, the search results pages generator 524 selects first those search results that have scores indicating that they have the highest likelihood of being relevant to the requesting user in generating the search results page(s).

Those skilled in the art will appreciate that at least some of the various components of the exemplary computing system 500 of FIG. 5 may, in one or more embodiments, be implemented as executable software modules within the computing system, as hardware modules (including SoCs—system on a chip), or a combination of the two. Moreover, each of the various components may be implemented as an independent, cooperative process or device, operating in conjunction with one or more computer systems. It should be further appreciated, of course, that the various components described above in regard to the exemplary computing device 500 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A method, as implemented through the execution of computer-executable instructions on a computing device comprising at least a processor and a memory, for responding to a search query, the method comprising:
receiving a search query from a requesting user, the search query identifying a query topic;
identifying a plurality of search results from a content index in response to the search query, wherein each of the plurality of search results is associated with a score indicative of a likelihood that the search result is relevant to the search query;
obtaining a user vector corresponding to the requesting user, the user vector containing user data obtained from user-generated content from a plurality of network sites;
weighting the scores of the plurality of search results according to the user vector;
selecting a subset of the plurality of search results based on the weighted scores and generating a search results page from the subset of search results; and
returning the generated search results page in response to the search query.

2. The method of claim 1 further comprising, repeatedly and independent of responding to a search query:
accessing a plurality of network sites;
obtaining user-generated content corresponding to the requesting user from the plurality of network sites; and
updating the user vector for the requesting user according to the user-generated content.

3. The method of claim 2, wherein obtaining user-generated content corresponding to the requesting user from the plurality of network sites comprises:
identifying user data of the requesting user from the user-generated content; and
wherein updating the user vector for the requesting user according to the user-generated content comprises updating the user vector for the requesting user according to the identified user data.

4. The method of claim 3 further comprising:
identifying a plurality of candidate advertisements for inclusion in the generated search results page, each candidate advertisement being associated with a score for inclusion in the generated search results page;
weighting the score of at least one candidate advertisement according to the user vector; and
generating the search results page from the subset of search results and including a subset of candidate advertisements.

5. The method of claim 4, wherein the user vector includes a plurality of data items corresponding to the requesting user.

6. The method of claim 5, wherein the plurality of data items included in the user vector include data items indicative of a positive or negative preference.

7. The method of claim 6, wherein the data items indicative of a positive or negative preference include an indication of the magnitude of the positive or negative preference.

8. The method of claim 7, wherein weighting comprises determining that a data item of the user vector is applicable to the search results and applying a weighting value associated with the data item to the score of the search result.

9. The method of claim 8, wherein weighting further comprises determining that a plurality of data items of the user vector are applicable to the search results and applying a weight value that is an aggregate of the applicable data items to the score of the search result.

10. The method of claim 9, wherein weighting the scores of the plurality of search results according to the user vector comprises altering the score associated with a first search result such that the first search result is more likely to be included in the generated search results page, and altering the score associated with a second search result such that the second search result is less likely to be included in the generated search results page.

11. The method of claim 9, wherein a data item of the user vector is indicative of a preference to an author of content, and wherein weighting the scores of the plurality of search results according to the user vector comprises determining that a third search result corresponds to content generated by the author and weighting the search results according to the magnitude of the preference to the author.

12. A computer-readable medium bearing computer-executable instructions which, when executed on a computer system comprising at least a processor, carry out a method for responding to a search query, the method comprising:
repeatedly and independent of responding to the search query:
accessing a plurality of network sites;
obtaining user-generated content corresponding to the requesting user from the plurality of network sites; and
updating the user vector for the requesting user according to the user-generated content;
receiving a search query from a requesting user, the search query identifying a query topic;
identifying a plurality of search results from a content index in response to the search query, wherein each of the plurality of search results is associated with a score indicative of a likelihood that the search result is relevant to the search query;
obtaining a user vector corresponding to the requesting user, the user vector containing user data obtained from user-generated content from a plurality of network sites;
weighting the scores of the plurality of search results according to the user vector;
selecting a subset of the plurality of search results having scores most indicative of the likelihood of being relevant to the search query and generating a search results page from the subset of search results; and
returning the generated search results page in response to the search query.

13. The computer-readable medium of claim 12, wherein obtaining user-generated content corresponding to the requesting user from the plurality of network sites comprises:
identifying user data of the requesting user from the user-generated content; and
wherein updating the user vector for the requesting user according to the user-generated content comprises updating the user vector for the requesting user according to the identified user data.

14. The computer-readable medium of claim 13, wherein the method further comprises:
identifying a plurality of candidate advertisements for inclusion in the generated search results page, each candidate advertisement being associated with a score for inclusion in the generated search results page;
weighting the score of at least one candidate advertisement according to the user vector; and
generating the search results page from the subset of search results and including a subset of candidate advertisements.

15. The computer-readable medium of claim 14, wherein the user vector includes a plurality of data items corresponding to the requesting user, and wherein the plurality of data items included in the user vector include data items indicative of a positive or negative preference, and wherein one or more of the data items indicative of a positive or negative preference include an indication of the magnitude of the positive or negative preference.

16. The computer-readable medium of claim 15, wherein weighting comprises determining that a data item of the user vector is applicable to the search results and applying a weighting value associated with the data item to adjust the score of the search result.

17. The computer-readable medium of claim 16, wherein weighting further comprises determining that a plurality of data items of the user vector are applicable to the search results and applying a weight value that is an aggregate of the applicable data items to adjust the score of the search result.

18. The computer-readable medium of claim 17, wherein a data item of the user vector is indicative of a preference to an author of content, and wherein weighting the scores of the plurality of search results according to the user vector comprises determining that a third search result corresponds to content generated by the author and weighting the search results according to the magnitude of the preference to the author.

19. A computer system for responding to a search query from a requesting user, the computer system comprising a processor and a memory, and further comprising:
a search results identifier that identifies a plurality of search results from a content store for responding to a search query, wherein each of the plurality of search results are associated with a score;
an ad selector that selects a plurality of candidate advertisements from an ad store for inclusion in the response to the search query, wherein each the plurality of candidate advertisements are associated with a score;
a personalization component that obtains a user vector corresponding to the requesting user from a user vector data store and:
applies weighting to the scores of the plurality of search results according to the user vector, wherein weighting a score of a search result comprises determining that a data item of the user vector is applicable to the search result and applying a weighting value associated with the data item to adjust the score of the search result; and
applies weighting to the scores of the plurality of candidate advertisements according to the user vector, wherein weighting a score of a candidate advertisement comprises determining that a data item of the user vector is applicable to the candidate advertisement and applying a weighting value associated with the data item to adjust the score of the candidate advertisement;
a search results page generator that generates a search results page from a subset of the plurality of search results having the most favorable scores of the plurality of search results, and includes a subset of the candidate advertisements having the most favorable scores of the candidate advertisements; and
a search query interface that receives the search query from the requesting user and, in response, provides the generated search results page to the requesting user.

20. The computer system of claim 19 further comprising:
a user-generated content access component that accesses user-generated content of the requesting user from a plurality of network sites;
a user data extraction component that identifies user data corresponding to the requesting user from the accessed user-generated content; and
a user vector update component that updates the user vector corresponding to the requesting user in the user vector data store according to the identified user data;
wherein the user-generated content access component, the user data extraction component, and the user vector update component periodically repeat the actions of accessing user-generated content, extracting user data from the user generated content, and updating the user vector independent of receiving the search query from the requesting user.
